(19) United States
(12) Patent Application Publication
(10) Pub. No.: US 2008/0101290 A1
(43) Pub. Date: May 1, 2008

(54) Apparatus for Arq Controlling in Wireless Portable Internet System and Method Thereof

(76) Inventors: Nak-Woon Sung, Daejeon-city (KR); Nam-Hoon Park, Daejeon-city (KR)

Correspondence Address: Jefferson IP Law, LLP, 1730 M Street, NW, Suite 807, Washington, DC, 20036, US

(21) Appl. No.: 11/721,510

(22) PCT Filed: Jun. 24, 2005
(86) PCT No.: PCT/KR05/01987

§ 371 Date: Jun. 12, 2007

(30) Foreign Application Priority Data
Dec. 14, 2004 (KR) 10-2004-0105589

(51) Int. Cl. H04Q 7/00

(52) U.S. Cl. 370/331

(57) ABSTRACT

The present invention relates to an ARQ control apparatus and method. According to the present invention, a subscriber station performs initialization by communicating with a base station, and receives wireless link channel quality information; stores an SDU in an SDU buffer when the SDU is transmitted from an upper block, and establishes a connection with the base station for a corresponding service flow; receives QoS information on the service flow, ARQ information, and a CINR, and transmits them to the uplink scheduler; detects a TCP header of the SDU and stores TCP sequence number information; and performs a DSC for controlling an MAC ARQ window size with reference to the QoS information, ARQ information, CINR, and TCP congestion window size.

### TECHNICAL FIELD

The present invention relates to an apparatus for automatic repeat request (ARQ) controlling to increase transmission control protocol (TCP) performance in a wireless portable internet system.

### BACKGROUND ART

Conventionally, split-connection approach, link layer approach, and protocol-based approach methods have been used to improve transmission control protocol (TCP) performance in wireless data communication.

The split-connection approach method is applied to the conventional TCP in a wired network, and it also uses an appropriate protocol for a wireless environment in a wireless link by splitting a TCP connection such that packet errors generated in the wireless link may not affect the wired network.

TCP performance is maximized in the wireless network according to the split-connection approach method. However, a base station used in this method has a heavy load because it performs an exchange between a wire protocol and a wireless protocol, and stores mapping information on every connection.

The link layer approach method uses a TCP packet stored in the base station without splitting the connection between the wired and wireless networks when the packet is lost or not effective due to an inappropriate condition of the wireless network.

The wireless TCP performance is increased with maintenance of the TCP connection between terminals of the wired and wireless networks according to the link layer approach method. However, the base station still has a heavy load because it stores the mapping information on every TCP connection and the packets used in each connection.

The protocol-based approach method uses a revised and developed TCP protocol to increase the wireless TCP performance.

The protocol-based approach method may be applied to a system without assistance of the base station, and the system operates regardless of a configuration of sub-systems. However, it is required to modify a TCP module in the wired network.

In addition, an ARQ algorithm has been suggested to minimize an error rate and to increase error correction performance in a wireless portable environment, specifically in a wireless internet system. The ARQ algorithm is for referring ACK and NACK messages for respective transmitted packets and retransmitting a lost packet with reference to a time-out period when the ACK and the NACK messages are not received.

A wireless potable internet system performs an ARQ operation in a TCP layer and in an MAC layer for establishing a wireless environment.

In order to perform an effective ARQ operation and improve TCP performance, a window size of the MAC ARQ layer is required to be varied according to a variation of the TCP receipt window in a dynamically changing wireless environment, and it is required to prevent retransmissions of the MAC ACR and the TAP layer from being overlapped.

When various service flows respectively having a quality of service (QoS) are provided, information of the AQR window size variation and wireless link channel quality is required to be used for scheduling policy.

In addition, at hand-off time, it is required to prevent a transmission period between TCP terminals from being increased by retransmission caused by a time-out.

### DISCLOSURE OF INVENTION

### Technical Problem

The present invention provides an ARQ control apparatus and method for flexibly controlling the MAC ARQ window size in a dynamic service change (DSC) process according to a variation of the TCP window size in a wireless potable internet system, and a method thereof.

The present invention also provides an ARQ control apparatus and method for controlling the MAC ARQ window size such that retransmissions of the MAC ARQ and the TCP layer may not be overlapped with each other in the wireless potable internet system, and for using information on the MAC ARQ window size for uplink scheduling policy.

The present invention also provides an ARQ control apparatus and method for performing fast retransmission and fast recovery operations by reducing a number of retransmission time-outs of the TCP receiver at hand-off time while changing the MAC ARQ window size, and for using the information on the MAC ARQ window size variation for the uplink scheduling policy by receiving wireless channel link information from a physical layer.

### Technical Solution

The present invention discloses an ARQ controller including a connection controller, a power and hand-off controller, an SDU buffer, an ARQ transmitter, a PDU framer, and an uplink scheduler. The connection controller performs initialization, establishes a connection with a base station, and receives negotiated ARQ information when a power is on. The power and hand-off controller periodically estimates a carrier-to-interference-and-noise ratio (CINR) between current frequencies, and transmits the CINR to the connection controller when a hand-off operation is required. The SDU buffer receives an SDU from a terminal equipment subsystem providing an internet service, updates a sequence number of a TCP packet, and stores the TCP packet. The ARQ transmitter receives the TCP packet from the SDU buffer, divides the TCP packet into MAC ARQ blocks having a predetermined size, and stores the divided packets in a fragment buffer. The PDU framer generates an MAP PDU from the divided packet fragments which are received from the ARQ transmitter, and transmits the MAP PDU to an uplink. The uplink scheduler instructs the PDU framer to generate the MAC PDU for respective service flows with reference to quality of service (QoS), MAC ARQ window size, MAC ARQ block size information on the respective service flows received from the connection controller, and a CINR value received from the power and hand-off controller.

At this time, the connection controller performs a dynamic service addition (DSA) process for generating the service flow when acknowledging a new service flow data packet from an upper block.

The connection controller performs a dynamic service change (DSC) for renegotiating with the base station when ARQ information including the current ARQ window and block sizes is required to be changed.

The present invention also discloses an ARQ control method. In the method, a subscriber station performs initialization by communicating with a base station, and receives wireless link channel quality information; the subscriber station stores an SDU in an SDU buffer when the SDU is transmitted from an upper block, and establishes a connection with the base station for a corresponding service flow; the subscriber station receives QoS information on the service flow, ARQ information, and a CINR, and transmits them to the uplink scheduler; the subscriber station detects a TCP header of the SDU and stores TCP sequence number information; and the subscriber station performs a DSC for controlling an MAC ARQ window size with reference to the QoS information, ARQ information, CINR, and TCP congestion window size.

In addition, the uplink scheduler determines an amount of PDU generation; a PDU framer stores fragments, the SDU divided into predetermined sizes, in order to perform an uplink transmission of an MAC PDU corresponding to the amount of the PDU generation; and a transmission buffer in an ARQ transmitter stores fragments corresponding to the uplink transmitted MAC PDU.

A TCP congestion window size is estimated with reference to the SDU stored in the SDU buffer and the sequence number of a TCP packet in the transmission buffer.

### Advantageous Effects

According to the exemplary embodiment of the present invention, the MAC ARQ window size is flexibly controlled according to the TCP window variation by the DSC process in the wireless portable internet system.

In addition, the MAC ARQ window size is controlled such that the retransmissions of the MAC ARQ and the TCP layer may not be overlapped in the wireless portable internet system, and the MAC ARQ window is used for the uplink scheduling policy.

Information on a wireless channel link is received from a physical layer, and the information is used for the MAC ARQ window size variation and the uplink scheduling policy.

The fast retransmission and fast recovery operations are performed by reducing a number of retransmission time-outs of the TCP receiver at the hand-off time.

Because the TCP performance of the wireless portable internet is improved by software of a terminal of the MAC layer, the base station is not required to store and manage the information on every TCP connection, and it is not required to change the wireless TCP module as the existing TCP module is changed.

### BRIEF DESCRIPTION OF THE DRAWINGS

FIG. 1 shows a TCP transmission configuration of a wireless potable internet system.

FIG. 2 shows a block diagram of a configuration of an automatic repeat request (ARQ) controller in the subscriber station according to the exemplary embodiment of the present invention.

FIG. 3 shows a diagram for representing a relation between a TCP window size and an MAC ARQ window size.

FIG. 4 shows graphs for respectively representing variations of the congestion window and the MAC ARQ window according to time and dynamic service change.

FIG. 5 shows a configuration diagram for performing the MAC ARQ window control and schedule operations according to the exemplary embodiment of the present invention.

FIG. 6 shows a flow chart for representing an uplink transmission method according to the exemplary embodiment of the present invention.

FIG. 7 shows a flow chart for representing the uplink and downlink data receipt and transmission, and the DSC process.

FIG. 8 shows a flow chart for representing an ARQ control method at the hand-off time according to the exemplary embodiment of the present invention.

### BEST MODE FOR CARRYING OUT THE INVENTION

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive. To clarify the present invention, parts which are not described in the specification are omitted, and parts for which similar descriptions are provided have the same reference numerals.

An automatic repeat request (ARQ) controller according to the exemplary embodiment of the present invention and a method thereof will be described with reference to figures.

In an IEEE 802.16 wireless portable internet system, the transmission control protocol (TCP) is for flexibly flowing a data packet according to a network condition by using a sliding window and a congestion control scheme. The TCP, a transmission protocol based on the ARQ scheme, uses cumulative ACKs and byte-based sequence numbers in order to sequentially and reliably transmit the data.

The TCP congestion control is for controlling an amount of packets being transmitted by combining additive increase/multiplicative decrease, slow start, fast re-transmission, and fast recovery methods. According to experiments, 99% of packet losses in the wired link are not generated by a transmission error but by a buffer overflow. Accordingly, a data rate is reduced while a retransmission time-out is interpreted as a congestion signal caused by an overload of the network. The additive increase/multiplicative decrease mode is for reducing a congestion window CWND by half when the network is congested, and reducing the CWND to 1 at the minimum when further packets are lost. The CWND is increased at a predetermined rate when a TCP receiver transmits the ACK.

A slow start mode is for quickly accessing a maximum transmittable bandwidth in a network by doubling the CWND for each round-trip time (RTT) when the TCP connection is established. The slow start mode is switched to a congestion avoidance mode when the CWND reaches a slow start threshold SSTHRESH. In the congestion avoidance mode, the CWND is increased by an inverse number of the current CWND every time the ACK is received, and therefore the CWND is linearly increased by a segment in an RTT

The fast retransmission mode is for retransmitting the lost packet without waiting for a time-out when a transmitter receives three duplicate ACKs, and therefore a number of time-out generations is reduced.

In the fast recovery mode, in order to prevent a number of the packets in a pipe from rapidly being reduced after a fast retransmission mode, the transmitter retransmits a lost packet while establishing the SSTHRESH to be half of the current CWND and another CWND to be ½*CWND+3 when three duplicate ACKs are received, and the CWND is increased by 1 every time a duplicate ACK arrives. A new packet is transmitted when the CWND is sufficiently increased to an appropriate value. The transmitter establishes the CWND to be SSTHRESH and operates in the congestion avoidance mode when the ACK for the transmitted packet is received.

The three duplicate ACKs for performing the fast retransmission mode indicate not only that the packet is lost but also that the packet is still being transmitted between a transmitter and a receiver because the receiver transmits the duplicate ACK when receiving a new packet. Accordingly, network resources are wasted when the slow start mode is performed after the fast retransmission mode is performed.

While the above methods for increasing the TCP performance in the wireless link have been suggested, as described in the description of the related art, there is a problem in that overload is caused by requiring the base station to store, detect, and map the information on every TCP connection, and the existing wired TCP module to be changed. Accordingly, in the exemplary embodiment of the present invention, the automatic repeat request (ARQ) controller reduces the load on the base station by storing, detecting, and mapping the TCP connection information in an MAC layer, and the existing wired TCP module is not required to be changed.

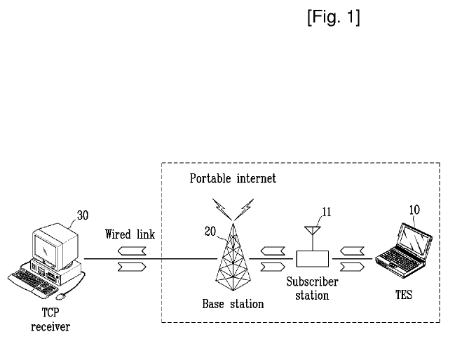

FIG. 1 shows a TCP transmission configuration of a wireless potable internet system.

A wireless potable internet system according to the exemplary embodiment of the present invention includes a terminal equipment subsystem (TES) 10, subscriber station (SS) 11, and a base station 20 which are wirelessly connected to each other. The wireless potable internet system may further include a TCP receiver 30 connected to the base station 20 by wire.

The terminal equipment subsystem 10 is a device including network protocols except a media access control (MAC) layer. The subscriber station 11 performs wireless communication with the base station 20 according to an MAC operation system, including an independent operation system and a processor. The terminal equipment subsystem 10 may be substituted with a notebook computer and a personal digital assistance (PDA), and the subscriber station 11 may be connected to the terminal equipment subsystem 10 through a universal serial bus (USB) interface or a personal computer memory card international association (PCMCIA) interface. Accordingly, in this specification, there will be separate reference to the terminal equipment subsystem 10 and the subscriber station 11 according to their functions.

While the terminal equipment subsystem 10 and the subscriber station 11 are separately described according to their functions, they may also be realized in a single integrated body.

The subscriber station 11 performs wireless communication with the base station according to the IEEE 802.16. The subscriber station transmits a packet generated in the terminal equipment subsystem to the base station according to a time division multiple access (TDMA) MAC operation scheme, and the base station transmits the packet to the TCP receiver 30.

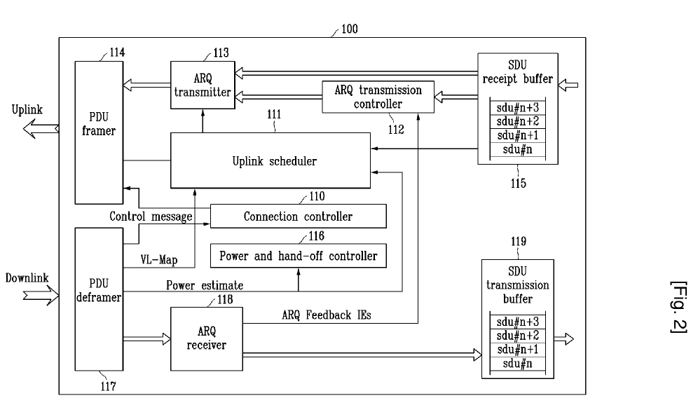

FIG. 2 shows a block diagram of a configuration of an automatic repeat request (ARQ) controller 100 in the subscriber station 11 according to the exemplary embodiment of the present invention.

The ARQ controller 100 according to the exemplary embodiment of the present invention includes a connection controller 110, an uplink scheduler 111, an ARQ transmission controller 112, an ARQ transmitter 113, a packet data unit (PDU) framer 114, a service data unit (SDU) receipt buffer 115, a power and hand-off controller 116, a PDU deframer 117, an ARQ receiver 118, and an SDU transmission buffer 119.

The ARQ controller 100 performs initialization with the base station by the connection controller 110 when power is applied. The connection controller 110 transmits a control message to the PDU framer 114, and the PDU framer 114 allocates an MAC PDU on an uplink bandwidth indicated by uplink MAP information (UL-MAP), and performs an uplink transmission of the MAC PDU.

The base station transmits an MAC management message for the transmitted MAC PDU as a response and the PDU deframer 117 transmits the MAC management message to the connection controller 110, and therefore an initialization process is performed. The PDU deframer receives radio link channel quality from a physical layer, and transmits the radio quality information to the power and hand-off controller 116 and the uplink scheduler 111.

When the initialization process is finished, a service data unit (SDU) transmitted from the terminal equipment subsystem 10 is stored in the receipt SDU buffer 115. At this time, the connection controller 110 generates a service flow in order to transmit a TCP data packet.

In the wireless potable internet, generation of the service flow is performed by a dynamic service addition (DSA) process. At this time, negotiations on quality of service (QoS), ARQ application, and ARQ mechanism for the service flow are performed between the base station and the subscriber station. When the service flow is generated by the DSA process, the connection is distinguished by a connection identifier (CID) and the CID information and the QoS information on the service flow are transmitted to the uplink scheduler 111. The connection is defined by a mapping relation between media access control (MAC) peers.

The DSA process is respectively performed on an uplink and a downlink. Information on the ARQ is transmitted to the ARQ transmitter 113 in an uplink DSA process, and transmitted to the ARQ receiver 118 in a downlink DSA process. The ARQ transmitter 113 fragments the SDU in the SDU receipt buffer 115 according to ARQ block sizes when the DSA process is successfully performed.

The uplink scheduler 111 performs a bandwidth request for transmitting divided fragments, and instructs the PDU framer to generate and transmit a predetermined amount of the MAC PDUs for the respective service flows. The PDU framer 114 receives the fragments from the ARQ transmitter, generates the MAC PDUs, and transmits the MAC PDUs to the uplink.

The transmitted fragment is stored in the ARQ transmitter for the ARQ management. The stored fragment is discarded when an ACK corresponding to an ARQ-feedback message of a downlink burst is received.

The PDU deframer 117 performs MAC header verification of the MAC PDUs downlink-transmitted, and the ARQ receiver 118 receives the MAC PDUs as the ARQ fragments. At this time, an ARQ feedback message is transmitted to the ARQ transmitter 113. The ARQ fragments transmitted to the ARQ receiver 118 are combined and transmitted to the SDU transmission buffer 119. The fragments combined and transmitted to the SDU transmission buffer 119 are transmitted to the terminal equipment subsystem 10, and therefore a web service is provided to a user of the terminal equipment subsystem.

An ARQ controlling operation of the subscriber station according to the exemplary embodiment of the present invention will now be described.

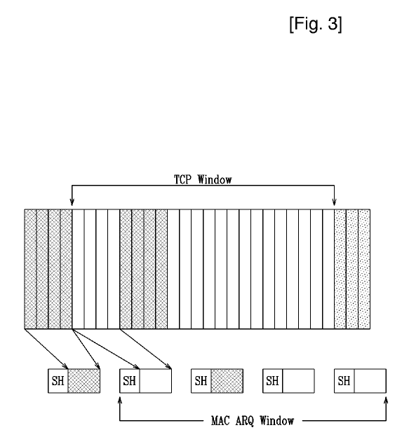

FIG. 3 shows a diagram for representing a relation between a TCP window size and an MAC ARQ window size.

As shown in FIG. 3, in a TCP layer, a plurality of data having byte-based sequence numbers are divided into ARQ blocks having block-based sequence numbers, and stored in a buffer. At this time, darkly illustrated areas denote data having received ACK after being transmitted.

The MAC ARQ block and window sizes are determined according to the negotiations of the above-described DSA process between the base station and the subscriber station. Accordingly, the MAC ARQ window size may be varied according to the TCP window size and a wireless link channel environment.

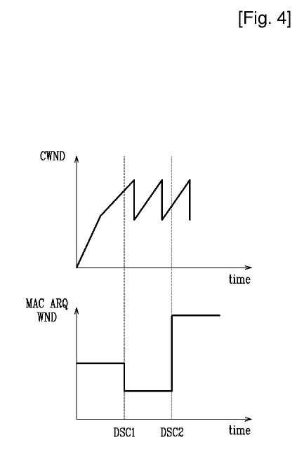

FIG. 4 shows graphs for respectively representing variations of the congestion window and the MAC ARQ window according to time and dynamic service change.

As described, when the service connection is established, a slow start mode is performed and the CWND size is increased in the TCP layer of the terminal equipment subsystem. When the CWND size reaches the SSTHRESH, the mode of the TCP layer is converted into the congestion avoidance mode, and converted into the slow start mode.

When the MAC layer has no information on the TCP layer although the window size is continuously increased in the TCP layer, the ARQ window size is maintained without any variation. In this case, transmission is delayed in the MAC ARQ block, and therefore the TCP receiver transmits the duplicate ACKs to the transmitter.

In this process, the TCP transmitter senses the duplicate ACKs as generation of the congestion, performs the fast retransmission and fast recovery modes, and transmits the duplicate TCP packet. Accordingly, a number of the duplicate packets re-transmitted from the TCP layer is further increased when the MAC ARQ window is reduced in the dynamic service change (DSC) 1 process shown in FIG. 4.

However, the transmission of the TCP layer is properly performed when the MAC ARQ window size is increased in the DSC 2 process regardless of the window size of the current TCP layer. However, another service flow is affected by increasing the MAC ARQ window size. In addition, the retransmission is further increased by the MAC ARQ block when the wireless link channel quality is inappropriate.

Accordingly, the MAC ARQ window size is required to be flexibly varied according to the CWND size of the TCP layer and the wireless channel link condition in order to increase the TCP performance. In a terminal having the MAC ARQ window size varied according to the TDMA MAC method, the uplink scheduler is required to establish a scheduling policy according to the variation of the TCP layer congestion window size and the wireless channel link condition.

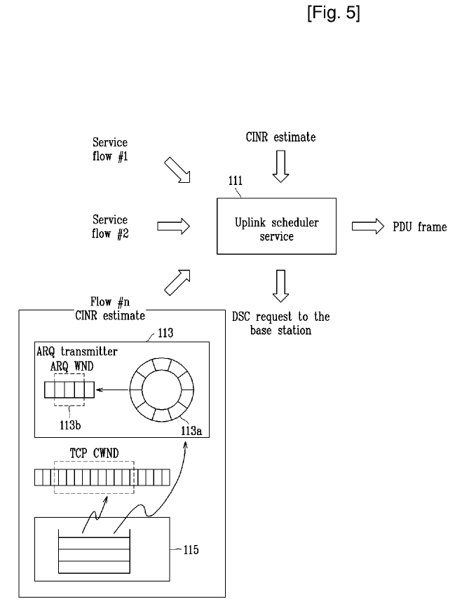

FIG. 5 shows a configuration diagram for performing the MAC ARQ window control and schedule operations according to the exemplary embodiment of the present invention.

The TCP data packet generated by the terminal equipment subsystem 10 is transmitted to the ARQ controller 100, and stored in the SDU receipt buffer 115. A value of the TCP CWND is updated by a service flow #n generated in the DSA process.

The stored SDU is divided into data of a fragment size defined between the subscriber station and the base station, is stored in a fragment buffer 113a when the uplink transmission quality is appropriate, and is discarded when the uplink transmission quality is inappropriate.

The subscriber station requests a bandwidth allocation for the stored fragments from the base station according to a weighted-fair-queuing scheduling policy of the uplink scheduler such that the fragments may satisfy QoS of the respective service flows. The subscriber station then generates an MAC PDU and transmits the generated MAC PDU through the allocated bandwidth. At this time, the fragments are transmitted by an amount corresponding to the current ARQ window size, and stored in a transmission buffer 113b.

The fragments stored in the transmission buffer 113b are discarded when the ACK message is received from the base station. However, the fragment is transmitted to a retransmission buffer and retransmitted by the uplink scheduler 111 when no ACK message is received from the base station for a predetermined time. At this time, the uplink scheduler 111 detects a header of the TCP packet and estimates the TCP CWND value.

The uplink scheduler determines whether the MAC ARQ window size of the current transmission buffer 113b is appropriate with reference to a current condition of the SDU receipt buffer 115 and a carrier-to-interference-and-noise ratio CINR reported for a predetermined time.

When the MAC ARQ window size is inappropriate, the uplink scheduler notifies the connection controller that a dynamic service change process for having an appropriate MAC ARQ window size is required so that the duplicate retransmission may not be performed by the TCP congestion control method. However, the frequent DSC process causes poor performance, and therefore, the DCS process is required when a difference between the CINR and the MAC ARQ window size is greater than a pre-determined threshold value. The proper threshold value may be derived from statistical experience such as experiments.

Weights (e.g. QoS, MAC ARQ window size, and CINR) on the scheduling is controlled by transmitting changed information of the MAC ARQ window size to the uplink scheduler 111, and therefore information on the MAC ARQ window size changed by generating the MAC PDU is used in the uplink transmission.

When the TCP data packet is not transmitted to the TCP receiver for micro seconds at a hand-off time, the TCP receiver may not proceed to perform any process until time-out is generated. Accordingly, the power and hand-off controller detects three duplicate ACKs generated in the SDU receipt buffer 115 when the hand-off starts, stores the three duplicate ACKs in a duplicate ACK buffer, and notifies the uplink scheduler 111 that the three duplicate ACKs are stored. The uplink scheduler transmits the three duplicate ACKs when the hand-off is finished, and therefore the TCP receiver may perform the fast retransmission and the fast recovery mode. The duplicate ACK buffer may be used by allocating a predetermined buffer provided in the ARQ transmitter.

That is, the packet is still being transmitted between the terminal equipment subsystems 10 and the TCP receiver 30 because the receiver may transmit the duplicate ACKs when receiving a new packet. Accordingly, a waste of network resources may be prevented when the slow start mode is not performed after the fast retransmission mode is performed.

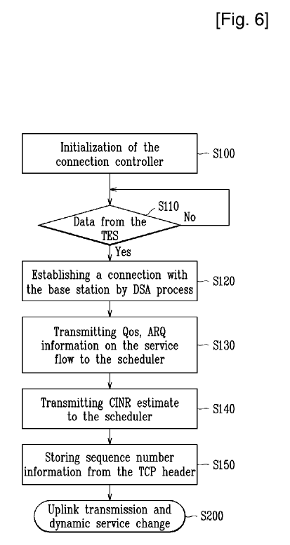

FIG. 6 shows a flow chart for representing an uplink transmission method according to the exemplary embodiment of the present invention.

The connection controller 110 performs initialization by communicating with the base station when a power is applied to the subscriber station. Through the initialization, the connection controller receives the wireless link channel quality information, and transmits the information to the power and hand-off controller 116 and the uplink scheduler 111 in step S100.

When the initialization is successfully performed and the subscriber station receives the data packet from the terminal equipment subsystem in step S110, the subscriber station establishes a connection corresponding to a service flow with the base station through the DSA process in step S120. The connection between the subscriber station and the base station is established by connection identifiers CIDs in the MAC layer through the DSA process. At this time, the connection is defined by a mapping relation between MAC peers, and the CIDs are provided corresponding to an amount of the generated service flows.

The packet transmitted from the terminal equipment subsystem is stored in the SDU receipt buffer, and information on the TCP sequence number is stored in the SDU receipt buffer and updated.

When connection is established through the DSA process, the subscriber station transmits the information on the service flow, QoS, and ARQ negotiated with the base station to the uplink scheduler, and allows the information to be used for scheduling policy in step S130.

The power and hand-off controller 116 estimates the CINR value and reports the CINR value to the uplink scheduler in step 140, and therefore the CINR value is used for changing the MAC ARQ window size.

The SDU receipt buffer detects the TCP header, and stores the TCP sequence number information in step S 150. The ARQ transmitter 113 receives the SDU from the SDU receipt buffer, and divides the SDU into predetermined sizes.

The subscriber station performs the uplink transmission with reference to the UL-MAP information, and performs the DSC process according to the received QoS and ARQ information in step S200.

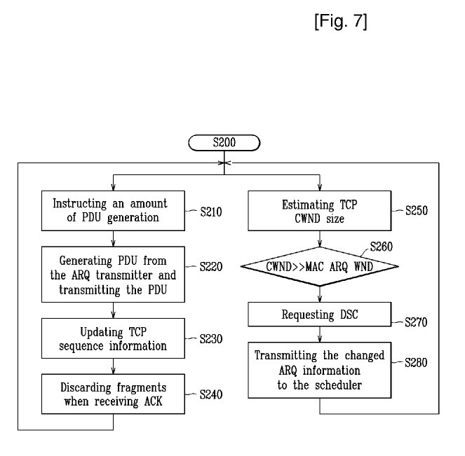

FIG. 7 shows a flow chart for representing the uplink and downlink data receipt and transmission, and the DSC process.

As described, when the connection between the base station and the subscriber station is established through the initialization and the DSA process, the uplink scheduler instructs the PDU framer to generate an amount of the PDUs with reference to the information on the QoS of the respective service flows and the information on the MAC ARQ window size in step S210.

The PDU framer receives the SDU divided into the predetermined sizes from the ARQ transmitter, converts the SDU into MAC PDUs corresponding to the amount of the generated PDUs, and transmits the MAC PDU through the uplink in step S220.

At this time, the ARQ transmitter stores fragments corresponding to the transmitted PDUs in the transmission buffer, and updates the TCP sequence number in step S230. The fragments are discarded from the transmission buffer when the ACK is received through the ARQ feedback message in a received downlink data burst.

The uplink scheduler estimates the size of the TCP CWND with reference to the sequence numbers of the packet in the current SDU buffer and the TCP packet in the transmission buffer for each frame in step S250.

At this time, the uplink scheduler determines whether the current MAC ARQ window size is less than the TCP CWND window and CINR when the TCP CWND window is great and the CINR is appropriate in step S260.

An additional DSC process may be omitted when a difference between the TCP CWND window size and the MAC ARQ size is not greater than a predetermined value.

However, when the CINR is appropriate and the duplicate transmission of the TCP layer is caused because the MAC ARQ window size is less than the TCP CWND size, the uplink scheduler requests the DSC process for changing the MAC ARQ window size to the connection controller such that the duplicate transmission may not be performed in step S270.

The connection controller increases the MAC ARQ window size, and transmits the changed ARQ information to the uplink scheduler such that the duplicate transmission may be prevented in step S280. Therefore the ARQ information is allowed to be used for the scheduling policy. At this time, the uplink scheduler performs a scheduling operation such that the MAC ARQ window size may be flexibly varied according to the TCP window size variations and the wireless link channel quality variations because the retransmission is performed by the MAC ARQ block when the wireless link channel quality is inappropriate.

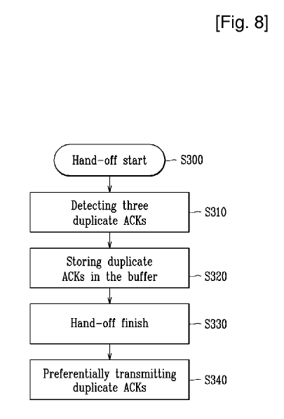

FIG. 8 shows a flow chart for representing an ARQ control method at the hand-off time according to the exemplary embodiment of the present invention.

The ARQ control method shown in FIG. 8 is used in an environment applied in the exemplary embodiment of the present invention described in FIG. 6 and FIG. 7.

The power and hand-off controller of the subscriber station senses a hand-off start in step S300. The hand-off start may be derived from the periodically estimated CINR value.

The subscriber station detects the three duplicate ACK messages from the terminal equipment subsystem in step S310.

The subscriber station stores the ACK messages in the duplicate ACK buffer, and notifies the uplink scheduler that the ACK messages are stored in the duplicate ACK buffer in step S320.

When the hand-off is finished, the power and hand-off controller senses a hand-off finish, and notifies the scheduler that the hand-off is finished in step S330.

The uplink scheduler preferentially transmits the ACK message stored in the ACK buffer in step S340.

According to the above configuration, the TCP receiver which does not perform any process by receiving no ACK message at the hand-off time preferentially receives the duplicate ACK messages when the hand-off is finished. Accordingly, the TCP receiver performs the fast retransmission and fast recovery without waiting for the time-out.

Accordingly, according to the exemplary embodiment of the present invention, resource wasting is prevented by steeply reducing the TCP congestion window when the hand-off is finished.

While this invention has been described in connection with what is presently considered to be the most practical and preferred embodiment, it is to be understood that the invention is not limited to the disclosed embodiment, but, on the contrary, is intended to cover various modifications and equivalent arrangements included within the spirit and scope of the appended claims.

1. An automatic repeat request (ARQ) controller for performing a dynamic service change in a wireless potable internet system, comprising:
a connection controller for performing initialization, establishing a connection with a base station, and receiving negotiated ARQ information when power is supplied;
a power and hand-off controller for periodically estimating a carrier-to-interference-and-noise ratio (CINR) between current frequencies, and transmitting the CINR to the connection controller when a hand-off operation is required;
a service data unit (SDU) buffer for receiving an SDU from a terminal equipment subsystem providing an internet service, updating a sequence number of a transmission control protocol (TCP) packet, and storing the TCP packet;
an ARQ transmitter for receiving the TCP packet from the SDU buffer, dividing the TCP packet into MAC ARQ blocks having a predetermined size, and storing the divided packets in a fragment buffer;
a personal data unit (PDU) framer for generating an MAP PDU from the divided packet fragments which are received from the ARQ transmitter, and transmitting the MAP PDU to an uplink; and
an uplink scheduler for instructing the PDU framer to generate the MAC PDU for respective service flows with reference to quality of service (QoS), MAC ARQ window size, MAC ARQ block size information on the respective service flows received from the connection controller, and a CINR value received from the power and hand-off controller.

2. The ARQ controller of claim 1, wherein the connection controller performs a dynamic service addition (DSA) process for generating the service flow when sensing a new service flow data packet from an upper block.

3. The ARQ controller of claim 2, wherein the connection controller performs a dynamic service change (DSC) for renegotiating with the base station when ARQ information including the current ARQ window and block sizes is required to be changed.

4. The ARQ controller of claim 3, wherein the ARQ transmitter stores the fragments transmitted to the PDU framer in a transmission buffer, and discards the stored fragments when being acknowledged by an ARQ feedback message.

5. The ARQ controller of claim 4, wherein the uplink scheduler estimates a congestion window of a TCP connection by using the packet in the SDU buffer and a TCP header in the transmission buffer, and notifies the estimated congestion window to the connection controller when the duplicate transmission is performed in the TCP layer and the MAC ARQ layer.

6. The ARQ controller of claim 4, further comprising:
a PDU deframer for receiving a downlink burst, eliminating a media access control (MAC) header and a cyclic redundancy code (CRC), transmitting a management message to the connection controller, detecting ARQ fragments, transmitting the detected ARQ fragments, and transmitting an ARQ feedback message of the detected ARQ fragments to the ARQ transmitter; and
an ARQ receiver for receiving the ARQ fragments from the PDU deframer, generating an SDU, transmitting the SDU to an upper block, generating an ARQ feedback message for the successfully received ARQ fragments, notifying the ARQ feedback message to the base station, and discarding the ARQ fragments which are not recombined for a predetermined period.

7. The ARQ controller of claim 5, wherein the uplink scheduler notifies the DSC process to the connection controller so as to increase the MAC ARQ window size when the CINR value is appropriate and the estimated TCP congestion window size is greater than the MAC ARQ window size over a threshold value.

8. The ARQ controller of claim 4, wherein the power and hand-off controller senses hand-off start and finish, detects and stores a plurality of duplicate ACK messages when the hand-off starts, and controls the duplicate ACK messages to be preferentially transmitted when the hand-off is finished.

9. An automatic repeat request (ARQ) control method in a wireless potable internet system, comprising:
performing initialization by communicating between a subscriber station and a base station, and receiving radio link channel quality information;
storing an SDU in an SDU buffer when the SDU is transmitted from an upper block, and establishing a connection between the subscriber station and the base station for a corresponding service flow;
receiving QoS information and ARQ information on the service flow, and a CINR, and transmitting the same to an uplink scheduler;
detecting a TCP header of the SDU and storing TCP sequence number information; and
performing a DSC for controlling an MAC ARQ window size with reference to the QoS information, ARQ information, CINR, and TCP congestion window size.

10. The ARQ control method of claim 9, further comprising:
the uplink scheduler determining an amount of PDU generation;
a PDU framer storing fragments divided into predetermined SDU sizes, in order to perform an uplink transmission of an MAC PDU corresponding to the amount of the PDU generation; and
a transmission buffer in an ARQ transmitter storing fragments corresponding to the uplink transmitted MAC PDU.

11. The ARQ control method of claim 10, further comprising estimating a TCP congestion window size with reference to the SDU stored in the SDU buffer and the sequence number of a TCP packet in the transmission buffer.

12. The ARQ controller of claim 10, wherein the DSC process comprises: increasing the MAC ARQ window size when the CINR is appropriate and the TCP congestion window size is greater than the MAC ARQ window size over a threshold value.

13. The ARQ control method of claim 9, further comprising:
a power and hand-off controller sensing hand-off start of a subscriber station;
the power and hand-off controller sensing a plurality of duplicate ACK messages from an upper block and storing the duplicate ACK messages in a buffer;
the power and hand-off controller sensing hand-off finish of the subscriber station; and
the power and hand-off controller preferentially transmitting the duplicate ACK messages.
